(19) United States
(12) Patent Application Publication
(10) Pub. No.: US 2025/0200200 A1
(43) Pub. Date: Jun. 19, 2025

(54) VIDEO PROCESS DEVICE, VIDEO PROCESS METHOD, AND NON-TRANSITORY RECORDING MEDIUM

(71) Applicant: TOYOTA JIDOSHA KABUSHIKI KAISHA, Toyota-shi (JP)

(72) Inventors: Sho HORIUCHI, Toyota-shi (JP); Yu INOUE, Kariya-shi (JP)

(73) Assignee: TOYOTA JIDOSHA KABUSHIKI KAISHA, Toyota-shi (JP)

(21) Appl. No.: 18/915,766

(22) Filed: Oct. 15, 2024

(30) Foreign Application Priority Data
Dec. 15, 2023 (JP) 2023-212034

(51) Int. Cl. G06F 21/62

(52) U.S. Cl. CPC G06F 21/6209

(57) ABSTRACT

A video process device stores associated information in which video shot by a drive recorder camera and identification information indicating identification result of a user of the drive recorder camera are associated, determines whether an access requestor to the video and the user of the drive recorder camera when the video was shot by the drive recorder camera are identical based on the identification information when an access to the video is requested, and permits the access requestor to access to the video when the access requestor to the video and the user of the drive recorder camera when the video was shot by the drive recorder camera are identical.

### CROSS-REFERENCE TO RELATED APPLICATION

This application claims priority to Japanese Patent Application No. 2023-212034 filed on Dec. 15, 2023, incorporated herein by reference in its entirety.

### FIELD

The present disclosure relates to video process device, video process method, and non-transitory recording medium.

### BACKGROUND

PTL 1 (Japanese Unexamined Patent Publication No. 2020-077237) describes a recording system for protecting the privacy of an occupant. Further, PTL 1 describes that when a drive recorder is mounted on vehicle, rent-a-car or the like which is jointly owned by a plurality of users, such as private conversation or the like of the occupant using the vehicle, the rent-a-car or the like is recorded in the drive recorder.

An occasion in which the vehicle having a drive recorder camera (also called as dashcam (dash cam)) is shared by multiple users is increasing, such as rent-a-car, car sharing or the like. The market for rent-a-car, car sharing or the like is expanding. Video shot by the drive recorder camera may include travel routes, life zones, faces or the like of users of rent-a-car, car sharing or the like. Therefore, a concise mechanism is desired to prevent the other user from accessing the video shot by the drive recorder camera when one user is using rent-a-car, car sharing or the like.

### SUMMARY

In view of the above-mentioned points, it is an object of the present disclosure to provide video process device, video process method, and non-transitory recording medium that can appropriately determine whether to permit to access to video shot by a drive recorder camera, for example, when the drive recorder camera is shared by multiple users.

(1) One aspect of the present disclosure is a video process device including a processor configured to: store associated information in which video shot by a drive recorder camera and identification information indicating identification result of a user of the drive recorder camera are associated; determine whether an access requestor to the video and the user of the drive recorder camera when the video was shot by the drive recorder camera are identical based on the identification information which is the other part of the associated information when an access to the video which is a part of the associated information is requested; and permit the access requestor to access to the video when the access requestor to the video and the user of the drive recorder camera when the video was shot by the drive recorder camera are identical.

(2) In the camera control device of the aspect (1), identification of the user of the drive recorder camera may be performed by using an image shot by a driver monitor camera.

(3) In the camera control device of the aspect (1), identification of the user of the drive recorder camera may be performed by using authentication information received by a smart phone which functions as a key used at least when a vehicle having the drive recorder camera is started.

(4) Another aspect of the present disclosure is a video process method including: storing associated information in which video shot by a drive recorder camera and identification information indicating identification result of a user of the drive recorder camera are associated; determining whether an access requestor to the video and the user of the drive recorder camera when the video was shot by the drive recorder camera are identical based on the identification information which is the other part of the associated information when an access to the video which is a part of the associated information is requested; and permitting the access requestor to access to the video when the access requestor to the video and the user of the drive recorder camera when the video was shot by the drive recorder camera are identical.

(5) Another aspect of the present disclosure is a non-transitory recording medium having recorded thereon a computer program for causing a processor to execute a process including: storing associated information in which video shot by a drive recorder camera and identification information indicating identification result of a user of the drive recorder camera are associated; determining whether an access requestor to the video and the user of the drive recorder camera when the video was shot by the drive recorder camera are identical based on the identification information which is the other part of the associated information when an access to the video which is a part of the associated information is requested; and permitting the access requestor to access to the video when the access requestor to the video and the user of the drive recorder camera when the video was shot by the drive recorder camera are identical.

According to the present disclosure, it is possible to appropriately determine whether to permit to access to video shot by a drive recorder camera, for example, when the drive recorder camera is shared by multiple users.

### BRIEF DESCRIPTION OF DRAWINGS

FIG. 1 is a view showing an example of a vehicle 1 to which a video process device 15 of a first embodiment is applied.

FIG. 2 is a flowchart for explaining an example of a process executed by a processor 153 of the video process device 15 of the first embodiment when shooting is performed by a drive recorder camera 14.

FIG. 3 is a flowchart for explaining an example of the process executed by the processor 153 of the video process device 15 of the first embodiment when a user of the drive recorder camera 14 requests access to recorded data or the like.

FIG. 4 is a view showing an example of the vehicle 1 to which the video process device 15 of a second embodiment is applied.

### DESCRIPTION OF EMBODIMENTS

Below, referring to the drawings, embodiments of video process device, video process method, and non-transitory recording medium of the present disclosure will be explained.

### First Embodiment

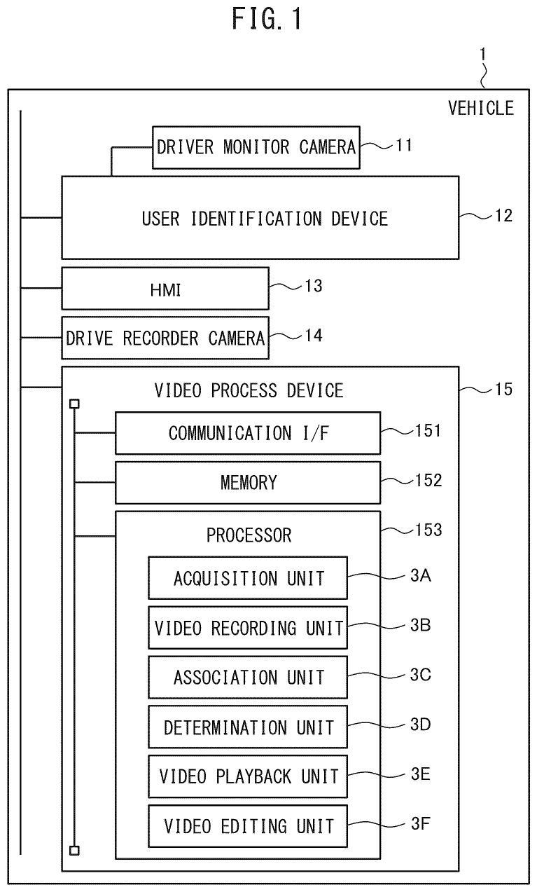

FIG. 1 is a view showing an example of a vehicle 1 to which a video process device 15 of a first embodiment is applied.

In the example shown in FIG. 1, the vehicle 1 includes driver monitor camera 11, user identification device 12, HMI (Human Machine Interface) 13, drive recorder camera 14, and video process device 15.

The driver monitor camera 11 is located, for example, at the top of a steering column of the vehicle 1 and shoots a part of face and upper body of a driver of the vehicle 1 (a user of the drive recorder camera 14). The driver monitor camera 11 transmits video data shot to the user identification device 12.

In another example, the driver monitor camera 11 may be located at a location other than the steering column, such as, for example, center cluster, room mirror, meter panel, meter hood or the like of the vehicle 1.

In the example shown in FIG. 1, the user identification device 12 identifies the user of the drive recorder camera 14 (the driver of the vehicle 1) included in an image shot by the driver monitor camera 11 by using face recognition technology and generates identification information indicating the identification result of the user of the drive recorder camera 14. That is, in the example shown in FIG. 1, identification of the user of the drive recorder camera 14 is performed by using the image shot by the driver monitor camera 11. The user identification device 12 transmits the identification information of the user of the drive recorder camera 14 to the video process device 15.

The HMI (Human Machine Interface) 13 has a function of receiving an operation of the driver riding on the vehicle 1 (the user of the drive recorder camera 14) to start the vehicle 1. That is, the HMI 13 includes engine switch, power switch or the like. The HMI 13 has the function of receiving the operation of the driver of the vehicle 1 (the user of the drive recorder camera 14) to request access to the video (recorded data) shot and recorded by the drive recorder camera 14. Furthermore, the HMI 13 has the function of receiving the operation of the driver of the vehicle 1 to playback the recorded data. Further, the HMI 13 has the function of receiving the operation of the driver of the vehicle 1 to edit (e.g., delete, etc.) the recorded data. The HMI 13 transmits the received signal indicating the operation of the driver of the vehicle 1 to the video process device 15.

The drive recorder camera 14 includes, for example, camera shooting the front of the outside of the vehicle 1, camera shooting the back of the outside of the vehicle 1, camera shooting the side of the outside of the vehicle 1, camera shooting the inside of the vehicle 1 and the like. In other words, the drive recorder camera 14 shoots the front of the outside of the vehicle 1, the back of the outside of the vehicle 1, the side of the outside of the vehicle 1, the inside of the vehicle 1 and the like and generates video data. Further, the drive recorder camera 14 transmits the video data shot to the video process device 15.

The video process device 15 executes process, playback, recording, and the like of the video shot by the drive recorder camera 14. The video process device 15 is configured by a microcomputer including communication interface (I/F) 151, memory 152, and processor 153. The communication interface 151 includes an interface circuit for connecting the video process device 15 to the user identification device 12, the HMI 13, the drive recorder camera 14, and the like. The memory 152 stores a program used in the process performed by the processor 153 and various data. The processor 153 has the function as an acquisition unit 3A, the function as a video recording unit 3B, the function as an association unit 3C, the function as a determination unit 3D, the function as a video playback unit 3E, and the function as a video editing unit 3F.

The acquisition unit 3A acquires the identification information generated by the user identification device 12. The acquisition unit 3A acquires the signal indicating the operation to start the vehicle 1 received by the HMI 13. In addition, the acquisition unit 3A acquires the signal indicating the operation to request the access to the recorded data received by the HMI 13. The acquisition unit 3A acquires the signal indicating the operation to playback the recorded data received by the HMI 13. The acquisition unit 3A acquires the signal indicating the operation to edit (e.g., delete, etc.) the recorded data received by the HMI 13. The acquisition unit 3A acquires the video data shot by the drive recorder camera 14.

The video recording unit 3B records the video shot by the drive recorder camera 14 in, for example, the memory 152 or the like.

The association unit 3C generates associated information in which the identification information acquired by the acquisition unit 3A and the video recorded by the video recording unit 3B are associated, and stores the associated information in the memory 152, for example.

When the HMI 13 receives the operation to request the access to the recorded data (the video shot by the drive recorder camera 14 and recorded by the video recording unit 3B), the determination unit 3D executes determination whether to permit the access to the recorded data.

Specifically, since the recorded data is a part of the associated information stored by the association unit 3C, the determination unit 3D determines whether an access requestor to the recorded data (the video shot by the drive recorder camera 14 and recorded by the video recording unit 3B) and the user of the drive recorder camera 14 when the video was shot by the drive recorder camera 14 are identical based on the identification information which is the other part of the associated information, when the access to the recorded data is requested.

That is, when the access to the recorded data is requested, the determination unit 3D determines whether to permit the access to the recorded data based on the identification information generated by the user identification device 12 based on the image shot by the driver monitor camera 11 and the associated information stored by the association unit 3C.

When the access requester to the recorded data (the video shot by the drive recorder camera 14 and recorded by the video recording unit 3B) and the user of the drive recorder camera 14 when the video was shot by the drive recorder camera 14 are identical, the determination unit 3D permits the access requester to access to the recorded data.

On the other hand, when the access requester to the recorded data (the video shot by the drive recorder camera 14 and recorded by the video recording unit 3B) and the user of the drive recorder camera 14 when the video was shot by the drive recorder camera 14 are not identical, the determination unit 3D restricts the access requester from accessing to the recorded data (i.e., does not permit the access requester to access to the recorded data).

When determination unit 3D permits the access to the recorded data, the video playback unit 3E performs playback of the recorded data (that is, makes the HMI 13 display the image recorded by the video recording unit 3B) based on the operation to playback the recorded data received by the HMI 13.

The video editing unit 3F performs editing of the recorded data (that is, performs editing such as deletion of the video recorded by the video recording unit 3B) based on the operation to edit the recorded data received by the HMI 13 when the determination unit 3D permits the access to the recorded data.

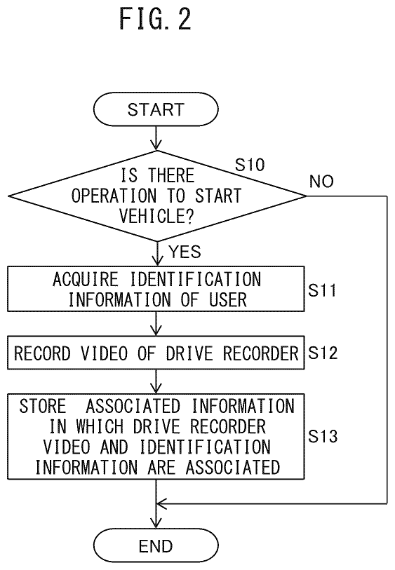

FIG. 2 is a flowchart for explaining an example of a process executed by the processor 153 of the video process device 15 of the first embodiment when shooting is performed by the drive recorder camera 14.

In the example shown in FIG. 2, at step S10, for example, the determination unit 3D determines whether the HMI 13 received the operation to start the vehicle 1. In the case of YES (i.e., when the user of the drive recorder camera 14 (the driver of the vehicle 1) got in the vehicle 1 and performed the operation to start the vehicle 1), the process proceeds to step S11, in the case of NO, the process shown in FIG. 2 ends.

At step S11, the acquisition unit 3A acquires the identification information of the user of the drive recorder camera 14 generated by the user identification device 12 by using the image of the user of the drive recorder camera 14 shot by the driver monitor camera 11.

At step S12, the video recording unit 3B records the video shot by the drive recorder camera 14.

At step S13, the association unit 3C generates and stores the associated information in which the identification information of the user of the drive recorder camera 14 acquired at step S11 and the video recorded at step S12 are associated.

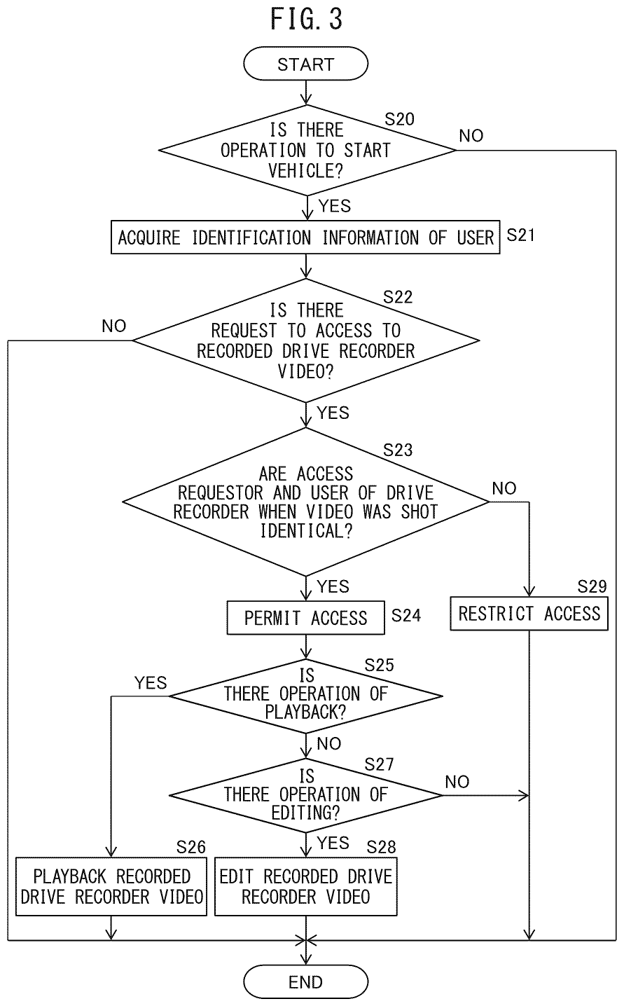

FIG. 3 is a flowchart for explaining an example of the process executed by the processor 153 of the video process device 15 of the first embodiment when the user of the drive recorder camera 14 requests the access to the recorded data (the video shot by the drive recorder camera 14 and recorded by the video recording unit 3B) or the like.

In the example shown in FIG. 3, at step S20, for example, the determination unit 3D determines whether the HMI 13 received the operation to start the vehicle 1. In the case of YES (i.e., when the user of the drive recorder camera 14 (the driver of the vehicle 1) got in the vehicle 1 and performed the operation to start the vehicle 1), the process proceeds to step S21, in the case of NO, the process shown in FIG. 3 ends.

At step S21, the acquisition unit 3A acquires the identification information of the user of the drive recorder camera 14 generated by the user identification device 12 by using the image of the user of the drive recorder camera 14 shot by the driver monitor camera 11.

At step S22, for example, the determination unit 3D determines whether the HMI 13 received the operation to request the access to the recorded data (the video shot by the drive recorder camera 14 and recorded at step S12). In the case of YES, the process proceeds to step S23, in the case of NO, the process shown in FIG. 3 ends.

At step S23, the determination unit 3D determines whether the access requestor to the recorded data (the video shot by the drive recorder camera 14 and recorded at step S12) and the user of the drive recorder camera 14 when the video was shot by the drive recorder camera 14 are identical based on the identification information which is the part of the associated information stored at step S13. If YES, the process proceeds to step S24; if NO, the process proceeds to step S29.

At step S24, the determination unit 3D permits the access requester to access to the recorded data.

At step S25, for example, the determination unit 3D determines whether the HMI 13 received the operation to playback the recorded data. If YES, the process proceeds to step S26; if NO, the process proceeds to step S27.

At step S26, the video playback unit 3E performs the playback of the recorded data based on the operation to playback the recorded data received by the HMI 13.

At step S27, for example, the determination unit 3D determines whether the HMI 13 received the operation to edit (for example, delete) the recorded data. In the case of YES, the process proceeds to step S28, in the case of NO, the process shown in FIG. 3 ends.

At step S28, the video editing unit 3F performs the editing of recorded data based on the operation to edit the recorded data received by the HMI 13.

At step S29, the determination unit 3D does not permit the access requester to access to the recorded data (i.e., restricts the access requester from accessing to the recorded data).

In the vehicle 1 to which the video process device 15 of the first embodiment is applied as described above, when the access requestor to the recorded data (the video shot by the drive recorder camera 14 and recorded by the video recording unit 3B) and the user of the drive recorder camera 14 when the video was shot by the drive recorder camera 14 are identical, the access requester is permitted to access to the recorded data. When the access requestor to the recorded data and the user of the drive recorder camera 14 when the video was shot by the drive recorder camera 14 are not identical, the access requester is restricted from accessing to the recorded data. Therefore, even when the drive recorder camera 14 mounted on the vehicle 1 is shared by multiple users, it is possible to suppress the risk that the video shot when one user is using the drive recorder camera 14 leaks to another user of the drive recorder camera 14.

In the vehicle 1 to which the video process device 15 of the first embodiment is applied as described above, the user of the drive recorder camera 14 does not need to perform a special operation such as a log-in operation or the like, the identification information of the user of the drive recorder camera 14 is generated by using the image of the user of the drive recorder camera 14 shot by the driver monitor camera 11, and the determination whether the access requestor to the recorded data (the video shot by the drive recorder camera 14 and recorded by the video recording unit 3B) and the user of the drive recorder camera 14 when the video was shot by the drive recorder camera 14 are identical is performed based on the identification information, permitting or restricting the access to the recorded data is performed. Therefore, it is possible to improve the convenience of the user of the drive recorder camera 14 than when the special operation such as the log-in operation or the like is required for the user of the drive recorder camera 14.

### Second Embodiment

The vehicle 1 to which the video process device 15 of a second embodiment is applied has the same structure as the vehicle 1 to which the video process device 15 of the first embodiment described above is applied, except that it will be described later.

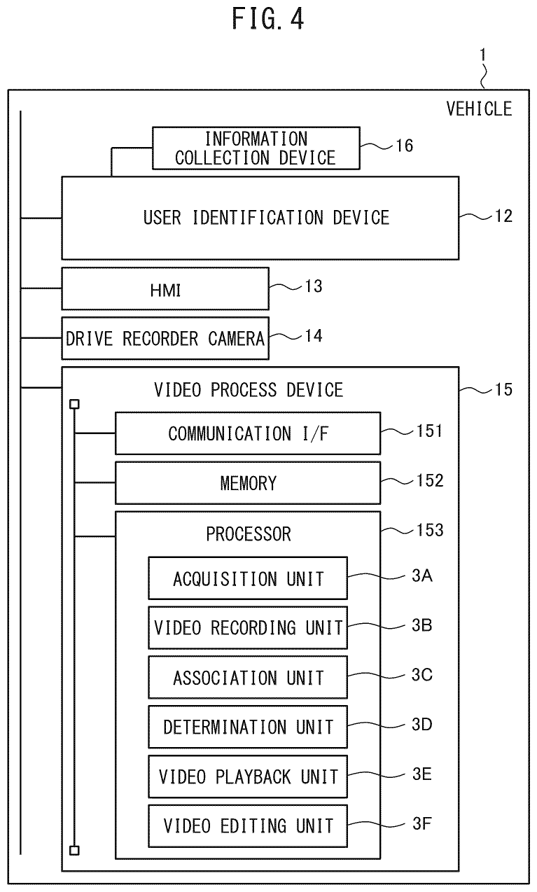

FIG. 4 is a view showing an example of the vehicle 1 to which the video process device 15 of the second embodiment is applied.

As described above, in the example shown in FIG. 1, the vehicle 1 includes the driver monitor camera 11. On the other hand, in the example shown in FIG. 4, the vehicle 1 includes an information collection device 16 used for identification of the user of the drive recorder camera 14.

In a first example of the vehicle 1 to which the video process device 15 of the second embodiment is applied, the information collection device 16 is configured by a smartphone having the function as a key for receiving the operation for opening and closing a door of the vehicle 1 and the operation for starting the vehicle 1. The information collection device 16 has the function of receiving authentication information such as fingerprint, passcode or the like used for the identification of the operator of the vehicle 1. The information collection device 16 transmits the received authentication information to the user identification device 12. The user identification device 12 identifies the user of the drive recorder camera 14 (the driver of the vehicle 1) by using the authentication information (for example, the fingerprint, the passcode, or the like) received by the information collection device 16 and generates the identification information indicating the identification result of the user of the drive recorder camera 14.

That is, in the first example of the vehicle 1 to which the video process device 15 of the second embodiment is applied, the identification of the user of the drive recorder camera 14 is performed by using the authentication information (for example, the fingerprint, the passcode, or the like) received by the smartphone which functions as the key used at the time of starting or the like of the vehicle 1 including the drive recorder camera 14.

In a second example of the vehicle 1 to which the video process device 15 of the second embodiment is applied, the information collection device 16 is configured by a finger vein sensor (scanner) which detects a finger vein of the driver of the vehicle 1 integrally provided with a steering device of the vehicle 1. That is, the information collection device 16 has the function of receiving biometric authentication information of the driver of the vehicle 1 (the user of the drive recorder camera 14). The information collection device 16 transmits the received biometric authentication information to the user identification device 12. The user identification device 12 identifies the user of the drive recorder camera 14 by using the biometric authentication information received by the information collection device 16 and generates the identification information indicating the identification result of the user of the drive recorder camera 14.

That is, in the second example of the vehicle 1 to which the video process device 15 of the second embodiment is applied, the identification of the user of the drive recorder camera 14 is performed by using the biometric authentication information detected by the finger vein sensor integrally provided with the steering device of the vehicle 1.

In a third example of the vehicle 1 to which the video process device 15 of the second embodiment is applied, the information collection device 16 is configured by the finger vein sensor (scanner) which detects the finger vein of the driver of the vehicle 1 provided in the vicinity of a door handle of the vehicle 1. That is, the information collection device 16 has the function of receiving the biometric authentication information of the driver of the vehicle 1 (the user of the drive recorder camera 14). The information collection device 16 transmits the received biometric authentication information to the user identification device 12. The user identification device 12 identifies the user of the drive recorder camera 14 by using the biometric authentication information received by the information collection device 16 and generates the identification information indicating the identification result of the user of the drive recorder camera 14.

That is, in the third example of the vehicle 1 to which the video process device 15 of the second embodiment is applied, the identification of the user of the drive recorder camera 14 is performed by using the biometric authentication information detected by the finger vein sensor provided in the vicinity of the door handle of the vehicle 1.

In a fourth example of the vehicle 1 to which the video process device 15 of the second embodiment is applied, the information collection device 16 is configured by a monitoring camera for parking of the vehicle 1. That is, the information collection device 16 shoots the face of the driver of the vehicle 1 (the user of the drive recorder camera 14) and transmits the shot image data to the user identification device 12. The user identification device 12 identifies the user of the drive recorder camera 14 (the driver of the vehicle 1) included in the image shot by the information collection device 16 by using the face recognition technology and generates the identification information indicating the identification result of the user of the drive recorder camera 14.

As described above, although the embodiments of the video process device, the video process method, and the non-transitory recording medium of the present disclosure has been described with reference to the drawings, the video process device, the video process method, and the non-transitory recording medium of the present disclosure are not limited to the embodiments described above, and appropriate changes can be made without departing from the scope of the present disclosure. The configuration of each example of the embodiments described above may be appropriately combined. In each example of the above-described embodiments, the process performed in the video process device 15 has been described as software process performed by executing the program, but the process performed by the video process device 15 may be the process performed by hardware. Alternatively, the process performed by the video process device 15 may be a combination of both software and hardware. The program stored in the memory 152 of the video process device 15 (the program for realizing the function of the processor 153 of the video process device 15) may be stored in a computer-readable storage medium (non-transitory recording medium) such as, for example, semiconductor memory, magnetic recording medium, optical recording medium, or the like to be provided and distributed.

1. A video process device comprising a processor configured to:
store associated information in which video shot by a drive recorder camera and identification information indicating identification result of a user of the drive recorder camera are associated;
determine whether an access requestor to the video and the user of the drive recorder camera when the video was shot by the drive recorder camera are identical based on the identification information which is the other part of the associated information when an access to the video which is a part of the associated information is requested; and
permit the access requestor to access to the video when the access requestor to the video and the user of the drive recorder camera when the video was shot by the drive recorder camera are identical.

2. The video process device according to claim 1, wherein
identification of the user of the drive recorder camera is performed by using an image shot by a driver monitor camera.

3. The video process device according to claim 2, wherein
identification of the user of the drive recorder camera is performed by using authentication information received by a smart phone which functions as a key used at least when a vehicle having the drive recorder camera is started.

4. A video process method comprising:
storing associated information in which video shot by a drive recorder camera and identification information indicating identification result of a user of the drive recorder camera are associated;
determining whether an access requestor to the video and the user of the drive recorder camera when the video was shot by the drive recorder camera are identical based on the identification information which is the other part of the associated information when an access to the video which is a part of the associated information is requested; and
permitting the access requestor to access to the video when the access requestor to the video and the user of the drive recorder camera when the video was shot by the drive recorder camera are identical.

5. A non-transitory recording medium having recorded thereon a computer program for causing a processor to execute a process comprising:
storing associated information in which video shot by a drive recorder camera and identification information indicating identification result of a user of the drive recorder camera are associated;
determining whether an access requestor to the video and the user of the drive recorder camera when the video was shot by the drive recorder camera are identical based on the identification information which is the other part of the associated information when an access to the video which is a part of the associated information is requested; and
permitting the access requestor to access to the video when the access requestor to the video and the user of the drive recorder camera when the video was shot by the drive recorder camera are identical.
